(19) United States
(12) Patent Application Publication
(10) Pub. No.: US 2015/0317812 A1
(43) Pub. Date: Nov. 5, 2015

(54) WEARABLE USER-CUSTOMIZABLE DISPLAY DEVICE

(71) Applicant: Margarita Louredo, WINTER PARK, FL (US)

(72) Inventor: Margarita Louredo, WINTER PARK, FL (US)

(21) Appl. No.: 14/269,430

(22) Filed: May 5, 2014

(51) Int. Cl. G06T 11/60; G09G 5/00; H04R 1/02

(52) U.S. Cl. CPC G06T 11/60; H04R 1/028; G09G 5/003; H04R 2499/10

(57) ABSTRACT

A wearable user-customizable display device includes a user attachment unit having a receptacle located along an outside surface. A display unit is removably secured within the receptacle, and the display unit includes a processor, a memory, a communication unit, and a display for projecting a motivational message.

### TECHNICAL FIELD

The present invention relates generally to jewelry, and more particularly to a piece of jewelry that includes a screen for displaying user created motivational messages and the like.

### BACKGROUND

The statements in this section merely provide background information related to the present disclosure and may not constitute prior art.

The public is bombarded with negative messages every day. These messages, some of which encourage destructive behavior are provided through television and radio programming and music. Tools or devices that provide an encouraging or motivational message can make a tremendous difference in minimizing the effects of negative messages in the lives of persons both young and old.

There are a number of known plaques, signs and posters, for example which are imprinted with a static motivational message that is applicable to a large percentage of the public. These items are designed to be placed in an office or home environment where anyone can see and receive the message.

However, many people set goals for themselves which may be unique and/or private in nature (e.g., a new year's resolution). For these people, a commercially generated static sign is not an appropriate means for generating a relevant motivational message for a particular user with a particular goal. Moreover, the user may wish to receive the motivational message at any time and location in a private manner that is not viewable by others. Finally, as a user progresses toward their goal, the user may want the motivational message to change, to reflect the progress made thus far.

Accordingly, the need exists for a device which can be worn by a user and can display any number of user-generated motivational messages.

### SUMMARY OF THE INVENTION

The present invention is directed to a wearable user-customizable display device. One embodiment of the present invention can include a user attachment unit having the shape and size of a piece of jewelry. The user attachment unit can include a receptacle for receiving a display device which can communicate with an external device in order to receive and display motivational messages to a user.

Another embodiment of the invention, can include a user attachment unit that has a main body taking the shape of a bracelet, a pendent or a broach, that are adorned with decorative elements such as jewels and markings.

In yet another embodiment, the receptacles and display units can include any number of complementary shapes and sizes, for use with the attachment units.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1A is a perspective view of a wearable user-customizable display device that is useful for understanding the inventive concepts disclosed herein.

FIG. 1B is a perspective view of a wearable user-customizable display device, in accordance with one embodiment of the invention.

FIG. 2 is a perspective view of the user attachment unit of the wearable user-customizable display device, in accordance with one embodiment of the invention.

FIG. 3A is a perspective view of the display unit of the wearable user-customizable display device, in accordance with another embodiment of the invention.

FIG. 3B is a simplified block diagram of the display unit of the wearable user-customizable display device, in accordance with one embodiment of the invention.

FIG. 4 is a perspective view of a wearable user-customizable display device, in accordance with another embodiment of the invention.

FIG. 5 is a perspective view of a wearable user-customizable display device, in accordance with yet another embodiment of the invention.

FIG. 6 is a perspective view of the wearable user-customizable display device, in accordance with another embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

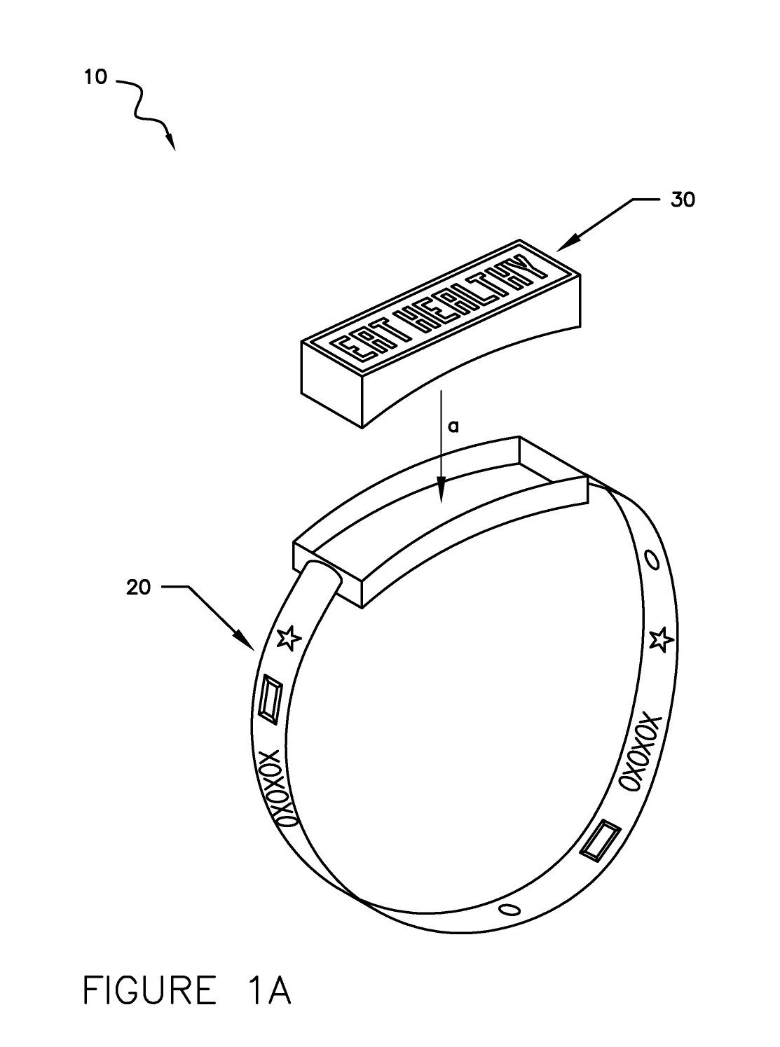

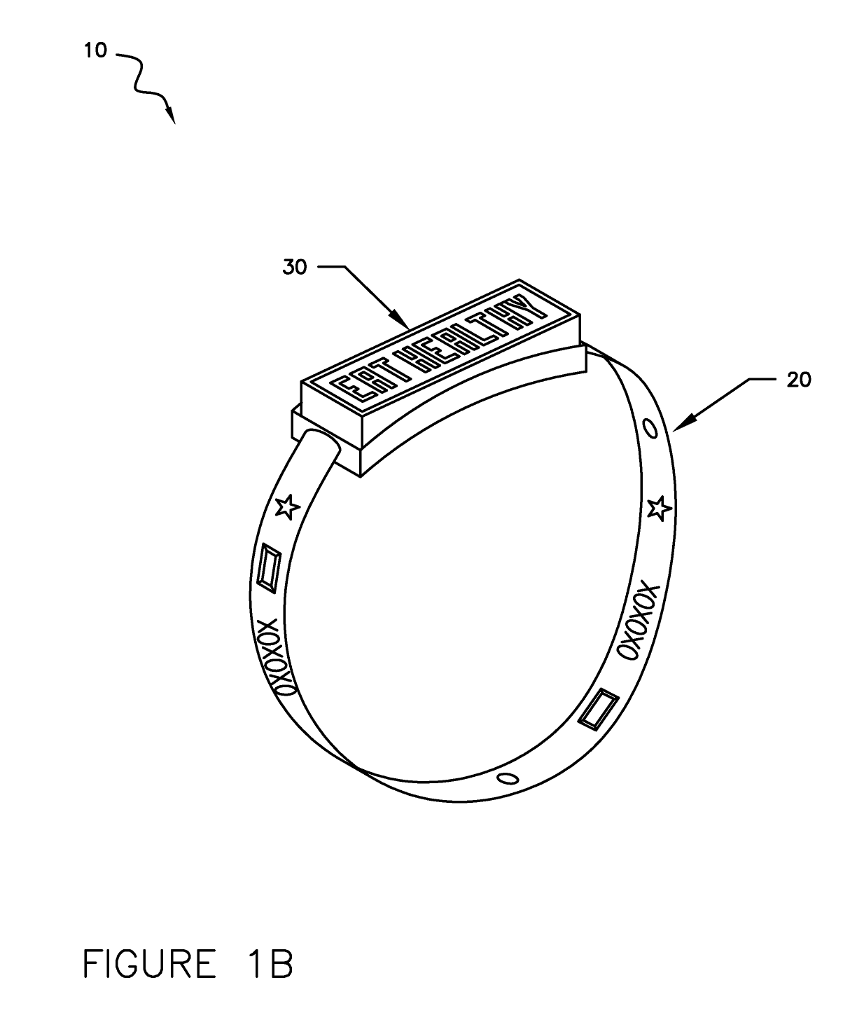

Identical reference numerals are used for like elements of the invention or elements of like function. For the sake of clarity, only those reference numerals are shown in the individual figures which are necessary for the description of the respective figure. As described herein, the term “removably secured” shall describe a situation wherein two or more objects are joined together in a non-permanent manner so as to allow the same objects to be repeatedly joined and separated. As described herein, the term “motivational message” and derivatives thereof can refer to any combination of letters, words, symbols, colors and the like, in any language and having any meaning. For purposes of this description, the terms “upper,” “bottom,” “right,” “left,” “front,” “vertical,” “horizontal,” and derivatives thereof shall relate to the invention as oriented in FIG. 1A.

FIGS. 1A and 1B illustrates one embodiment of a wearable user-customizable display device 10, that is useful for understanding the inventive concepts disclosed herein. As shown, the device 10 can include, essentially, one or more user attachment units 20 having a shape and size that resembles wearable jewelry, and a display unit 30 which can be removably connected (see arrow A) to the user attachment unit.

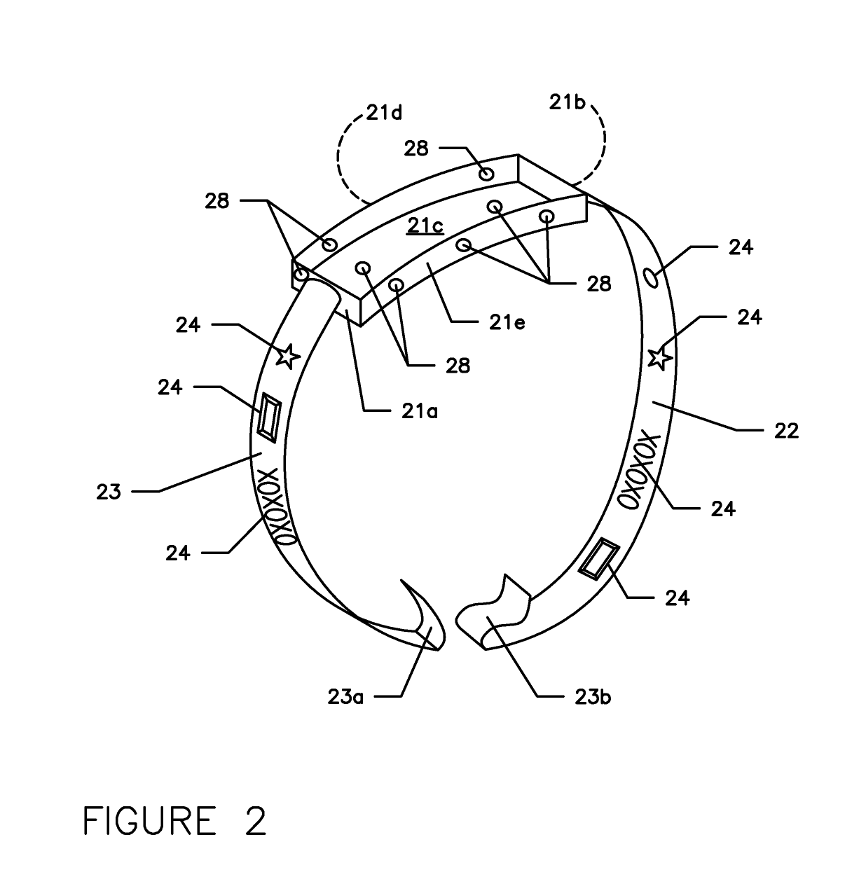

FIG. 2, illustrates one embodiment of a user attachment unit having a main body that is in the shape of a bracelet 20. As shown, the bracelet 20 can include a receptacle 21 that is interposed between a pair of opposing bracelet bands 22 and 23. The receptacle 21 can function to receive and securely position the display unit 30 onto the member 20. As such, the receptacle 21 can include a generally curved rectangular shape having a first end 21a, a second end 21b, a bottom surface 21c and a pair of opposing side surfaces 21d and 21e, each forming a cavity for receiving the display unit 30.

The bracelet 20, including the bracelet bands 22 and 23 can each be constructed from any number of suitable materials such as gold, silver, platinum, leather, rubber, cloth and/or composite materials such as nylon, for example. Each of the bands can also include any number of markings and/or decorative elements 24 including jewels such as diamonds, emeralds, sapphires, rubies, pearls and opals, as well as markings such as words, letters, symbols, and other such elements that can be deposited onto the bracelet for decorative purposes. In the illustrated embodiment, each of the bands 22 and 23 include a clasp 22a and 23a, respectively for engaging and securing the bands together along the arm of a user.

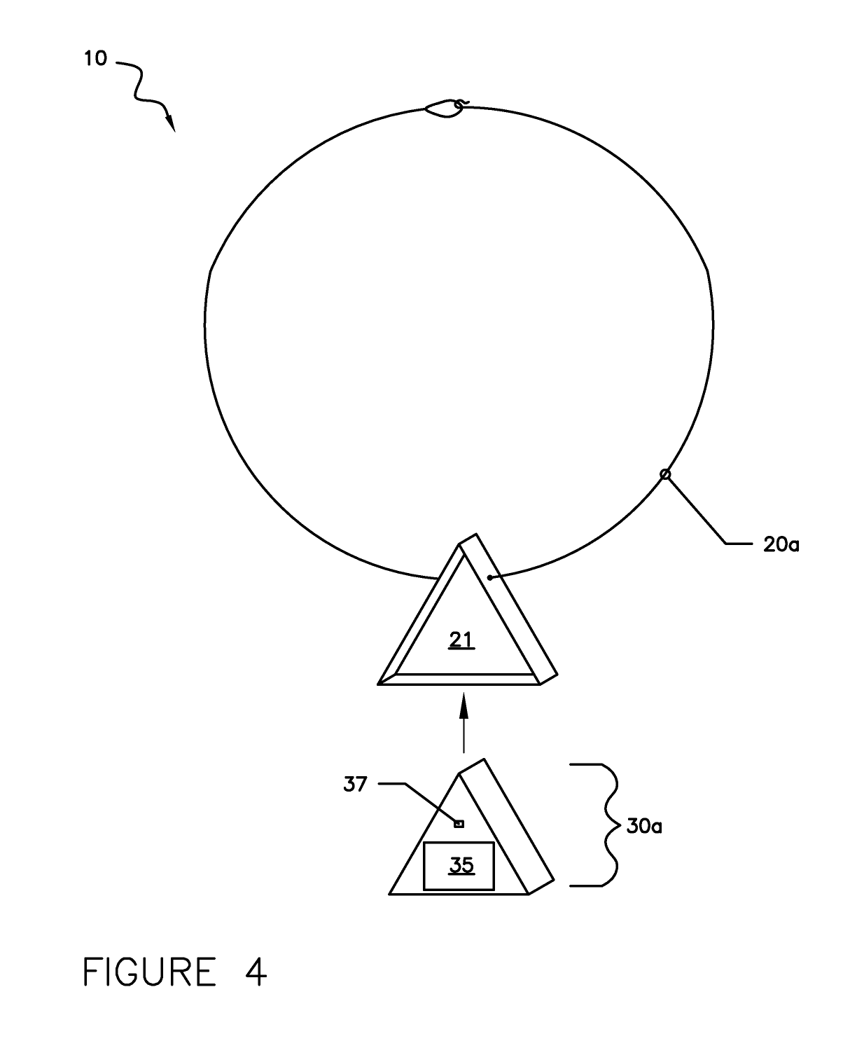

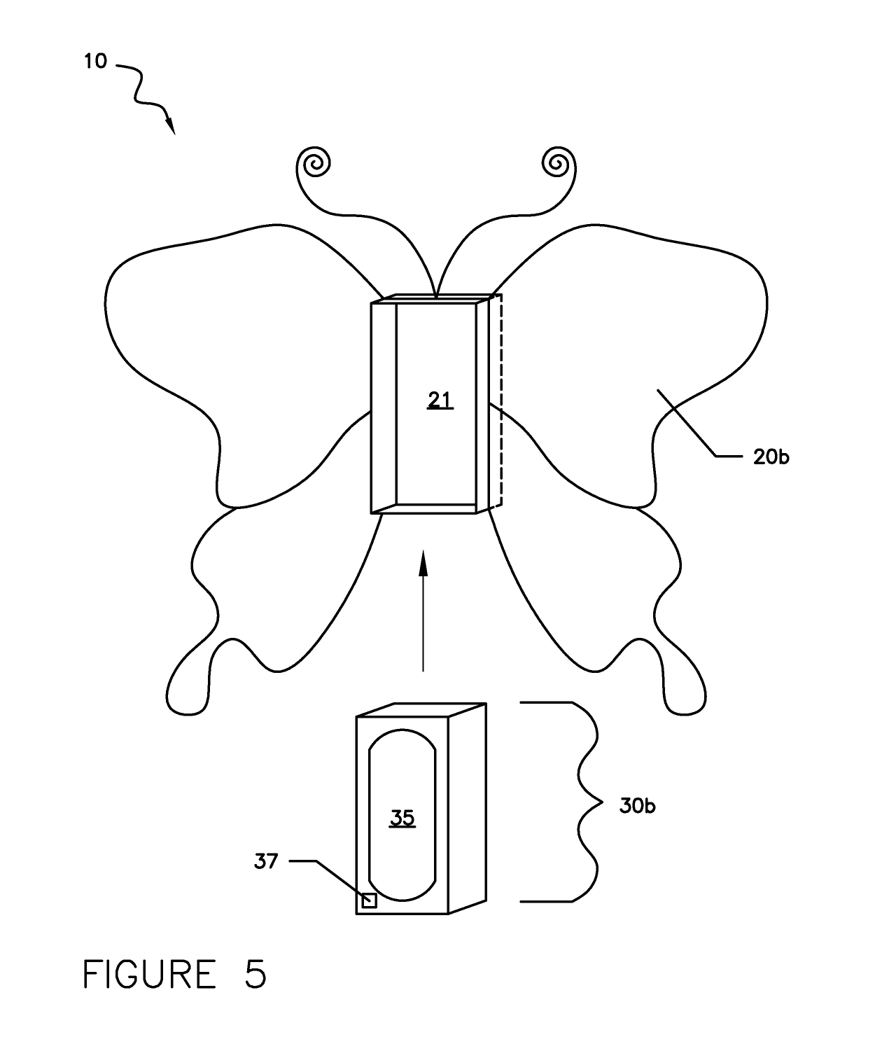

Although described as a bracelet including a pair of bands 22 and 23 that are connected via clasps, the user attachment unit is not limited to such a configuration. In this regard, any number of other attachment units are also contemplated, such as the unitary band illustrated in FIGS. 1A and 1B, for example. Moreover, although described above with respect to particular shapes, sizes and/or construction materials, this is for illustrative purposes only. As such, those of skill in the art will recognize that the attachment unit 20 can take any number of different shapes and sizes (See FIGS. 4 and 5 below) and can be constructed utilizing any number of different construction materials and can include an unlimited number of decorative elements, and colors, without deviating from the scope and spirit of the inventive concepts described herein. Additionally, the receptacle 21 can also include any number of different shapes and sizes in order to removably secure display units having different shapes and sizes. In this regard, both the receptacle 21 and the display unit 30 can always include shapes and sizes that are complementary to one another, in order to allow the receptacle to receive and engage the display unit 30 in a nonpermanent manner.

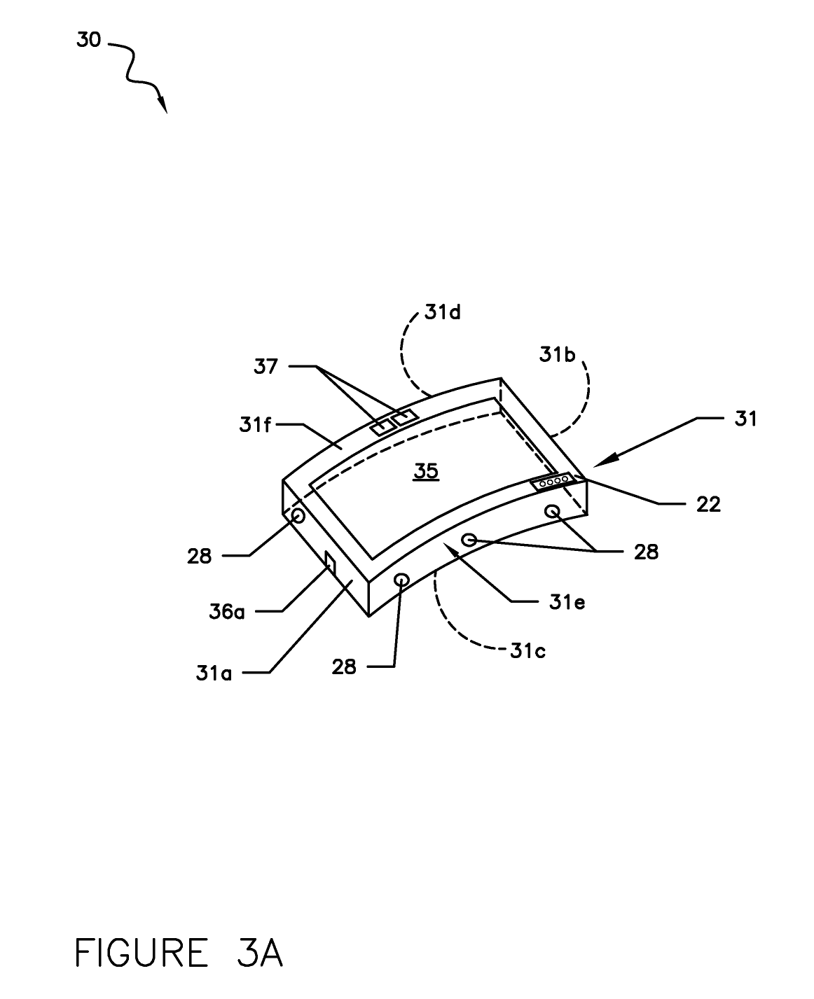

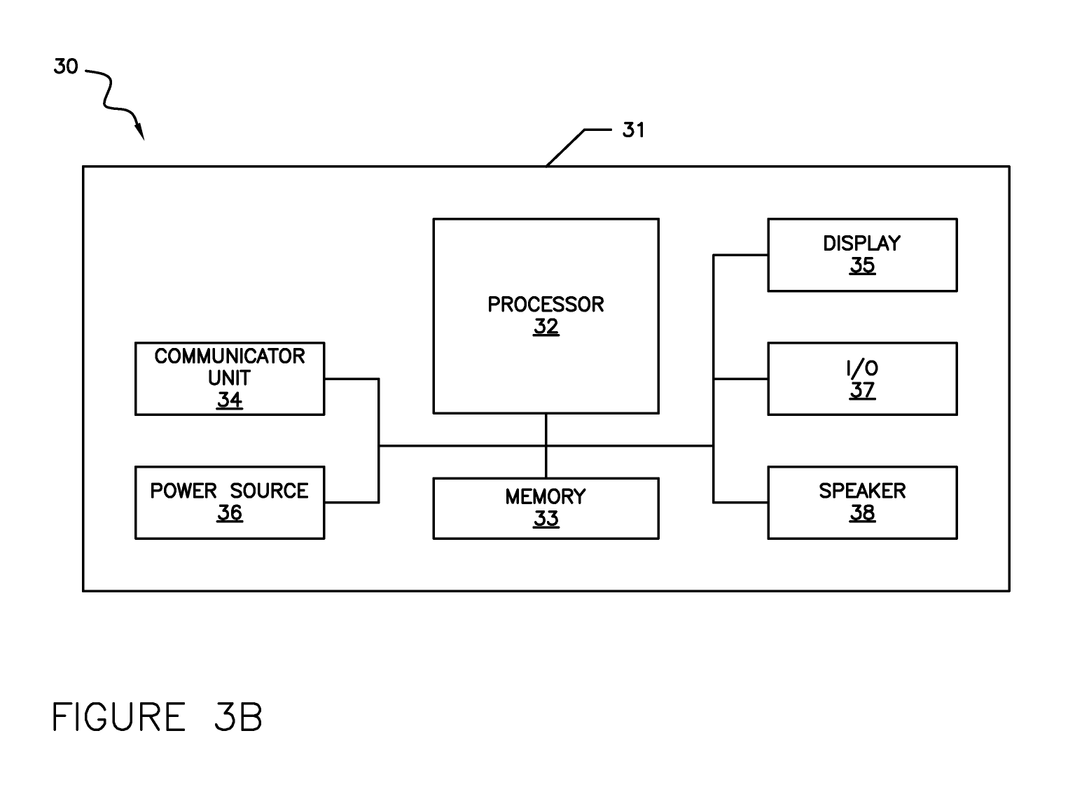

FIGS. 3A and 3B illustrate one embodiment of a display unit 30. As shown, the display unit can include a main body 31 having a processor 32 that is conventionally connected to an internal memory 33, a communication unit 34, a display 35, a power source 36, an input/output unit 37, and an optional speaker 38.

Although illustrated as separate elements, those of skill in the art will recognize that one or more system components may be, or include, one or more printed circuit boards (PCB) containing an integrated circuit or circuits for completing the activities described herein. The CPU may be one or more integrated circuits having firmware for causing the circuitry to complete the activities described herein.

The main body 31 of the display unit can preferably include an elongated, generally curved rectangular shape that is complementary to the shape of the receptacle 21, described above, in order to allow the display unit 30 to be securely and removably secured within the receptacle 21, as shown with respect to FIG. 1. In one preferred embodiment, display body 31 can be constructed from injection molded plastic having a plurality of internal connectors (not shown) for securely positioning each of the elements 32-37.

Although described above as including a particular shape and construction material, the main body 31 can include many other shapes such as triangular 30a (See FIG. 4), oval 30b (See FIG. 5) and square, for example, and can be constructed from any number of other known materials and manufacturing processes. In each instance, the receptacle 21 and main body 31 will include nearly identical/complementary shapes in order to allow the main body 31 to be secured within the receptacle 21 of the attachment unit 20. Moreover, the device 10 can also include a plurality of connectors 28 which can be disposed along one or both of the display unit main body 31, the receptacle 21 and/or the main body of the user attachment unit.

As described herein, the connectors 28 can include, for example, strips of hook and loop material, opposing magnetic elements, and/or compression fittings such as snaps and compression tabs, for example, which can function together (i.e., complementary connectors) to repeatedly engage and disengage two items together. Moreover, the connectors 28 can also include features for permanently securing two or more items together in a non-removable manner. Several nonlimiting examples including adhesives, welds, and hardware such as screws, nuts and bolts, for example.

The processor/CPU 32 can act to execute program code stored in the memory 33 in order to allow the device to perform the functionality described herein. Processors are extremely well known in the art, therefore no further description will be provided.

Memory 33 can act to store operating instructions in the form of program code for the processor 32 to execute. Although illustrated in FIG. 3B as a single component, memory 33 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device. Additionally, memory 33 can also include one or more cache memories that provide temporary storage of at least some program code in order to reduce the number of times program code must be retrieved from the bulk storage device during execution. Each of these devices are well known in the art.

The communication unit 34 can include any number of devices capable of communicating with an external device either directly or over a network. In one preferred embodiment, the communication unit can include a Bluetooth transceiver for communicating wirelessly with an external device such as a smartphone, computer and/or tablet device running an application (i.e., App) for sending and receiving information with the display unit. For example, the communication unit can receive information from a smartphone app containing a motivational message that is to be displayed on the visual display 35. However, any number of other known transmission and reception mechanisms and protocols can also be utilized herein, several nonlimiting examples include unique radio frequencies, infrared (IR), RFID, and/or a network adapter functioning to communicate over a WAN, LAN or the internet, for example.

The visual display unit 35, can include virtually any known device capable of presenting information, such as a motivational message, in a digital format to a user via a screen. Several nonlimiting examples include LCD displays, plasma, LED displays, electro-luminescent displays and the like. Additionally, the display unit 35 can also include a Graphic User Interface (GUI) capable of performing two way communication with a device user. In some embodiments, a GUI screen can function both as the display and the input/output unit described below.

In one preferred embodiment, the power source 36 can include one or more DC batteries capable of providing the necessary power requirements to each element of the display unit 30. In one embodiment, the batteries can be permanently located within the main body and can be rechargeable in nature via a charging port 36a, such as a mini or micro USB port, for example. Of course, traditional batteries can also be utilized and the main body can further include a battery compartment having a removable cover (not illustrated) for allowing a user to access the same.

One or more input/output units, such as the buttons 37 can act to accept user inputs and provide instructions to the processor. In one preferred embodiment, each of the buttons can be connected to the processor 32 so as to activate different programmatic functions. For example, one of the buttons 37 can function to switch the electronic components of the device between an ON and OFF state, can initiate a sleep mode, and/or can act to pair the communication unit 34 of the device 10 with an external device (e.g., the users smartphone), and so on.

The speaker 38 can function in a conventional manner to play an audible sound such as a pre-recorded tone or music, for example, which can be stored in the memory. The speaker can be controlled by the processor, and can be activated at any time based on the instructions provided to the processor via the external user device and/or the input/output unit 37.

Although illustrated above with respect to a bracelet, the invention is not so limited as the attachment unit 20 can take a variety of different shapes to suit the particular likes and interests of a user. As shown in FIGS. 4 and 5 the attachment unit can include a necklace pendent 20a and a broach 20b, for example, each having a receptacle 21 that has a size and shape that is complementary to a particular display unit 30a and 30b, respectively.

As would be known to one of skill in the art, the above list is merely illustrative, as the attachment unit can take virtually any shape and can include limitless possibilities with respect to color, markings, logos, construction materials and designs which can be incorporated and/or embedded into the attachment unit(s).

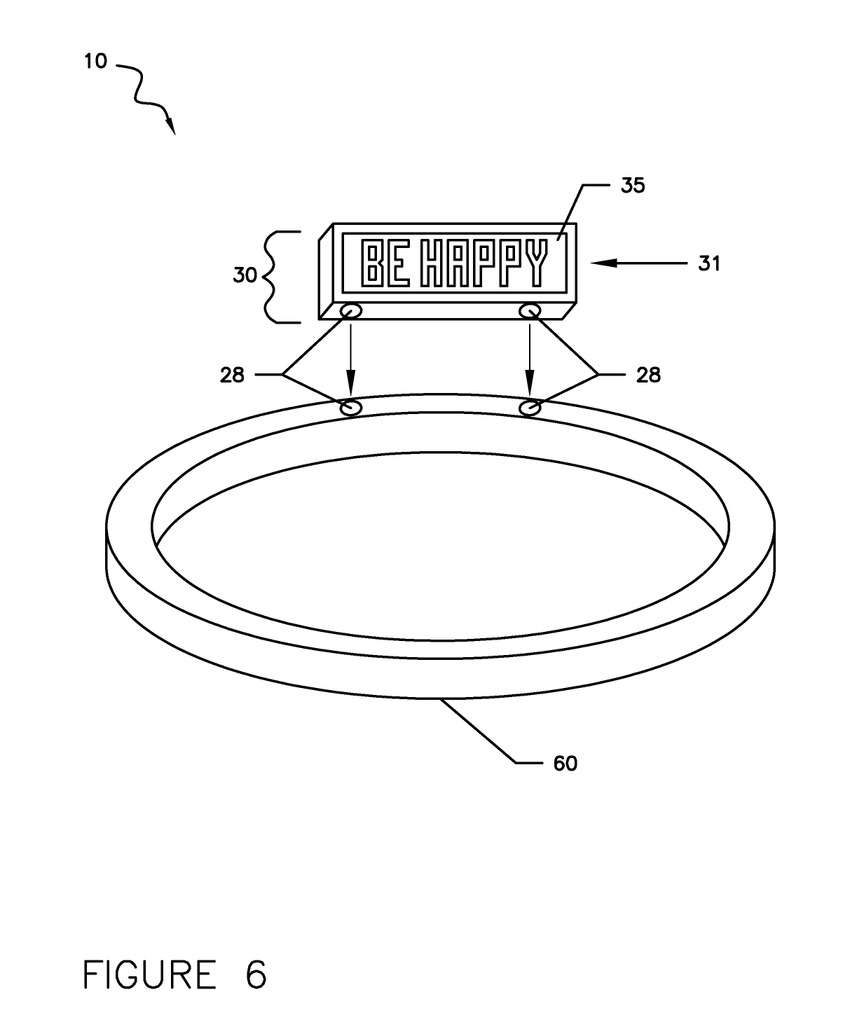

FIG. 6 illustrates another embodiment of the wearable user-customizable display device 10, wherein the main body of the user attachment unit, in this example, a solid bracelet 60 includes a plurality of connectors 28 for directly engaging the complementary connectors 28 located on the display body 31. In this regard, the device 10 can function to receive and position a display unit 30 in either a permanent or removable manner directly onto the user attachment member without the aid of a receptacle.

By providing a plurality of design choices with respect to the attachment units 20, 20a and 20b, a user can pick and choose which attachment unit they want to wear for any given occasion and simply insert the display unit 30 into the receptacle of that member. As such a single display unit can be interchangeable with multiple attachment units 20, in order to allow a user to continually change the look and feel of the device 10, thus keeping up with current fashion trends while still maintaining the ability to view a motivational message at any time.

Accordingly, the above described device can function to receive any number of motivational messages from an external user device, and display the same on the device screen 35 for private viewing any time by the user. In this regard, the messages displayed on the screen can be static in nature, or can be dynamic wherein they scroll across the screen in any direction. The messages can also include shapes and sounds, and can be in color, or in black and white.

As described herein, one or more elements of the wearable user-customizable display device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the attachment unit 20, 20a and/or 20b can be permanently affixed to the display member 30, 30a and 30b to form one continuous element, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A wearable user-customizable display device, said device comprising:
a user attachment unit that includes
a main body having a shape and size that approximates a piece of jewelry, and
a receptacle disposed along a surface of the user attachment unit; and
a display unit that includes
a display body having a shape and size that is complementary to a shape and size of the receptacle,
a display screen functioning to display a motivational message in a digital format, and
a communication unit functioning to communicate with an external device to receive the motivational message,
wherein, the display body and the receptacle include complementary shapes and dimensions, and the display body is configured to be secured within the receptacle in at least one of a permanent and a removable manner.

2. The device of claim 1, wherein the main body of the user attachment unit is a bracelet, and each of the receptacle and the display body include an elongated, generally curved rectangular shapes.

3. The device of claim 2, wherein the bracelet includes a pair of bracelet bands, each having a clasp for engaging the bands about the arm of a user, and each of the bracelet bands further include decorative elements.

4. The device of claim 3, wherein the bracelet bands are constructed from, at least one of gold, silver, platinum, leather, rubber, cloth and a composite material, and the decorative elements include at least one of a jewel and a marking.

5. The device of claim 1, wherein the display unit further includes:
a speaker configured to produce an audible output;
an input output unit configured to receive user instructions,
a memory that is configured to store operating instructions; and
a processor that is in communication with each of the communication unit, the speaker, the input output unit, the memory and the display,
wherein the processor is configured to instruct the display to show the motivational message upon receiving a signal from the communication unit.

6. The device of claim 5, wherein the communication unit consists of a Bluetooth transceiver configured to communicate with an external smartphone running an App.

7. The device of claim 5, wherein the display includes at least one of an LCD display, a plasma display, an LED display and an electronic luminescent display.

8. The device of claim 5, wherein the display and the input output unit consist of a single Graphic User Interface.

9. The device of claim 1, further comprising:
one or more DC batteries that are disposed within the display body, and
a charging port that is disposed along a surface of the display body.

10. The device of claim 1, wherein the main body of the user attachment unit is a pendent, and each of the receptacle and the display body include generally triangular shapes.

11. The device of claim 1, wherein the main body of the user attachment unit is a broach, and each of the receptacle and the display body include generally oval shapes.

12. The device of claim 1, wherein the motivational message includes a static message.

13. The device of claim 1, wherein the motivational message includes a dynamic message.

14. A wearable user-customizable display device, said device comprising:
a user attachment unit that includes
a main body having a shape and size that approximates a piece of jewelry, and
a plurality of connectors that are disposed along the main body; and
a display unit that includes
a main display body having a plurality of complementary connectors disposed thereon, said connectors and said complementary connectors functioning to secure the display unit onto the user attachment unit in one of a permanent and a removable manner,
a display screen functioning to display a motivational message in a digital format, and
a communication unit functioning to communicate with an external device to receive the motivational message.

15. The device of claim 14, wherein the main body of the user attachment unit includes at least one of a bracelet, a pendent and a broach.

16. The device of claim 14, wherein the display unit further includes:
a speaker configured to produce an audible output;
an input output unit configured to receive user instructions,
a memory that is configured to store operating instructions; and
a processor that is in communication with each of the communication unit, the speaker, the input output unit, the memory and the display,
wherein the processor is configured to instruct the display to show the motivational message upon receiving a signal from the communication unit.

17. The device of claim 16, wherein the communication unit consists of a Bluetooth transceiver configured to communicate with an external smartphone running an App.

18. The device of claim 16, wherein the display includes at least one of an LCD display, a plasma display, an LED display and an electronic luminescent display.

19. The device of claim 16, wherein the display and the input output unit consist of a single Graphic User Interface.

20. The device of claim 14, wherein the motivational message includes at least one of a static message and a dynamic message.
